(19) United States
(12) Patent Application Publication
(10) Pub. No.: US 2020/0191222 A1
(43) Pub. Date: Jun. 18, 2020

(54) SHOCK ABSORBING ANGLE BARRIER

(71) Applicant: McCue Corporation, Peabody, MA (US)

(72) Inventor: Teodoro A. Mesa, Lynn, MA (US)

(21) Appl. No.: 16/712,108

(22) Filed: Dec. 12, 2019

Related U.S. Application Data
(60) Provisional application No. 62/778,647, filed on Dec. 12, 2018.

(51) Int. Cl. F16F 1/373; F16F 1/376; F16F 7/00

(52) U.S. Cl. CPC F16F 1/3737; F16F 1/376; F16F 7/00; F16F 1/50; F16F 2230/0041; F16F 2230/36; F16F 2224/025; F16F 2234/06

(57) ABSTRACT

An impact absorbing barrier for attachment to a surface includes an elongate member including a first elongate section configured to rest on the surface, the first elongate section including a number of through holes disposed along its length, and a second elongate section extending from the first elongate section in a direction substantially away from the surface. The impact absorbing barrier also includes a number of impact absorbing fastening mechanisms, each including a fastener configured to extend through a corresponding through hole of the first elongate section and into the surface.

### CROSS-REFERENCE TO RELATED APPLICATIONS

This application claims the benefit of U.S. Provisional Application No. 62/778,647 filed Dec. 12, 2018, the contents of which are incorporated herein by reference.

### BACKGROUND

This invention relates to a shock absorbing angle barrier.

Warehouses, distributions centers, factories, and retail stores often have equipment and/or people moving around their facilities. In the process of moving about the facilities, the equipment and/or people may make contact with assets in the facilities, possibly causing damage to the assets.

### SUMMARY

Aspects described herein are directed to a shock absorbing angle barrier that can be strategically placed in facilities to prevent equipment and/or people from causing damage to assets in the facilities. Advantageously, aspects include shock absorbing features that allow equipment and/or people to make contact with the barrier while reducing damage to the barrier, the equipment and/or people, and a surface to which the barrier is mounted. Specifically, the barrier is able to flex and return to its original state to prevent damage.

In a general aspect, an impact absorbing barrier for attachment to a surface includes an elongate member including a first elongate section configured to rest on the surface, the first elongate section including a number of through holes disposed along its length, and a second elongate section extending from the first elongate section in a direction substantially away from the surface. The impact absorbing barrier also includes a number of impact absorbing fastening mechanisms, each including a fastener configured to extend through a corresponding through hole of the first elongate section and into the surface.

Aspects may include one or more of the following features.

The second elongate section may extend transverse to the surface. Each impact absorbing fastening mechanism of the number of impact of impact absorbing fastening mechanisms may include a shock absorber including a through hole and configured for placement on the second elongate section. Each impact absorbing fastening mechanism of the number of impact of impact absorbing fastening mechanisms may further include a washer disposed on the shock absorber. The fastener may be configured to extend through the washer, the shock absorber, and the second elongate section such that a distal end of the fastener is secured in the surface and a flange disposed at a proximal end of the fastener is prevented from passing through the shock absorber by the washer.

The fastener may be a concrete anchor. The shock absorber may be made of an elastomeric material. The elongate member may have a substantially “L” shaped cross-sectional profile. The elongate member may be made of steel. The elongate member may be made of plastic.

The first elongate section may have a first edge and a second edge and the second elongate section may have a third edge and a fourth edge, the first edge of the first elongate section may be mechanically connected to the third edge of the second elongate section.

Aspects may have one or more of the following advantages.

Among other advantages, unlike conventional barriers, aspects are able to absorb impact forces without causing damage to the barrier. The barriers need to be replaced less often and are less likely to damage objects that strike the barriers.

Other features and advantages of the invention are apparent from the following description, and from the claims.

### DESCRIPTION OF DRAWINGS

FIG. 1 is a perspective view of a shock absorbing angle barrier.

FIG. 2 is a front view of the shock absorbing angle barrier of FIG. 1.

FIG. 3 is a top view of the shock absorbing angle barrier of FIG. 1.

FIG. 4 is a side view of the shock absorbing angle barrier of FIG. 1 including a shock absorption mechanism.

### DESCRIPTION

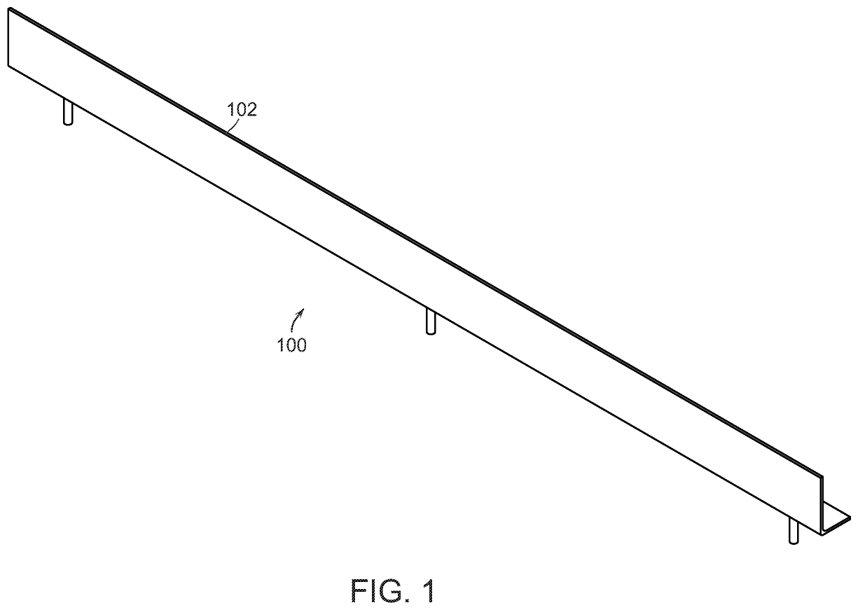

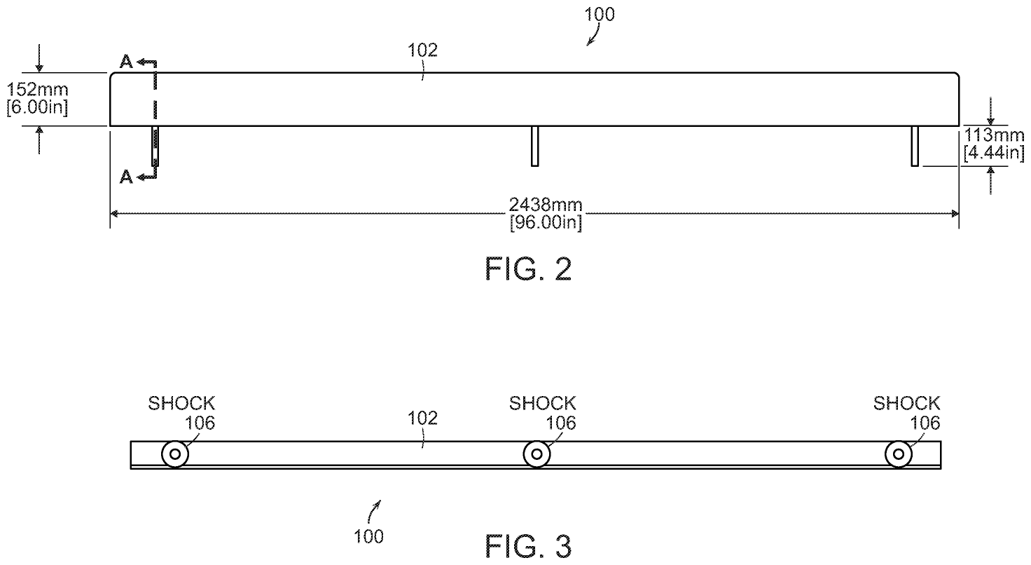

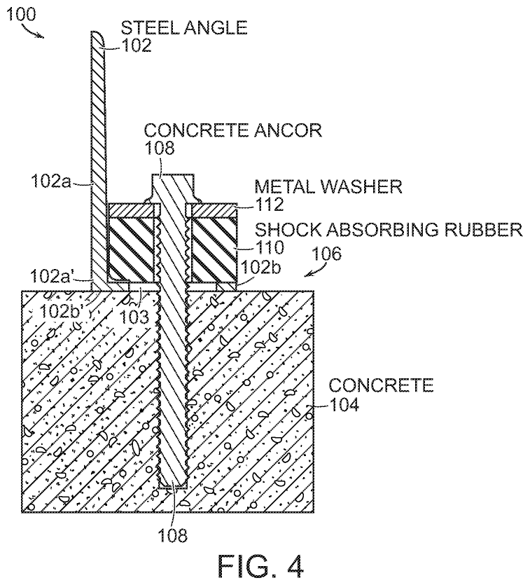

Referring to FIGS. 1-4, a shock absorbing angle barrier 100 includes an elongate metallic member 102 that is configured to be secured to a surface 104 using a number of impact absorption mechanisms 106.

The elongate metallic member 102 is an elongate, substantially ‘L’ shaped member with an upright leg 102a and a ground contacting leg 102b. As is shown in the figures, upright leg 102a has an edge 102a′ that extends transversely from an edge 102b′ of ground contacting leg 105b. The ground contacting leg 102b includes a number of through holes 103 through which corresponding fasteners 108 of the impact absorbing mechanisms 106 extend for fastening the elongate metallic member 102 to the surface 104.

Each of the impact absorbing mechanisms 106 includes a shock absorbing rubber member 110 with a through hole extending therethrough. The shock absorbing rubber member 110 is disposed on the ground contacting leg 102b of the elongate metallic member 102 with its through hole aligned with a corresponding through hole 103 in the elongate metallic member 102. A metal washer 112 including a through hole is disposed on the shock absorbing rubber member 110 with its through hole aligned with the through hole of the shock absorbing rubber member 110.

The fastener 108 mentioned above (e.g., a concrete anchor) extends through the through hole in the metal washer 112, through the through hole in the shock absorbing rubber member 110, through the through hole 103 in the elongate metallic member, and into the surface 104, where it is fixed. A flange 114 of the fastener 108 contacts the washer 112 and holds the washer 112 and the shock absorbing rubber member 110 captive between the flange 114 and the ground contacting leg 102b of the elongate metallic member 102.

In some examples, the impact absorbing mechanisms 106 include similar or the same features as the impact absorbing mechanisms described in U.S. Pat. No. 8,444,343, which is incorporated herein by reference.

In some examples, the elongate metallic member 102 is formed from steel. In some examples, the elongate metallic member 102 is formed from plastic such as high density polyethylene (HDPE).

It is to be understood that the foregoing description is intended to illustrate and not to limit the scope of the invention, which is defined by the scope of the appended claims. Other embodiments are within the scope of the following claims.

What is claimed is:

1. An impact absorbing barrier for attachment to a surface, the impact absorbing barrier comprising:
an elongate member including:
a first elongate section configured to rest on the surface, the first elongate section including a plurality of through holes disposed along its length, and
a second elongate section extending from the first elongate section in a direction substantially away from the surface; and
a plurality of impact absorbing fastening mechanisms, each including a fastener configured to extend through a corresponding through hole of the first elongate section and into the surface.

2. The impact absorbing barrier of claim 1 wherein the second elongate section extends transverse to the surface.

3. The impact absorbing barrier of claim 1 wherein each impact absorbing fastening mechanism of the plurality of impact of impact absorbing fastening mechanisms includes a shock absorber including a through hole and configured for placement on the second elongate section.

4. The impact absorbing barrier of claim 4 wherein each impact absorbing fastening mechanism of the plurality of impact of impact absorbing fastening mechanisms further includes a washer disposed on the shock absorber.

5. The impact absorbing barrier of claim 5 wherein the fastener is configured to extend through the washer, the shock absorber, and the second elongate section such that a distal end of the fastener is secured in the surface and a flange disposed at a proximal end of the fastener is prevented from passing through the shock absorber by the washer.

6. The impact absorbing barrier of claim 1 wherein the fastener is a concrete anchor.

7. The impact absorbing barrier of claim 3 wherein the shock absorber is made of an elastomeric material.

8. The impact absorbing barrier of claim 1 wherein the elongate member has a substantially “L” shaped cross-sectional profile.

9. The impact absorbing barrier of claim 1 wherein the elongate member is made of steel.

10. The impact absorbing barrier of claim 1 wherein the elongate member is made of plastic.

11. The impact absorbing barrier of claim 1 wherein the first elongate section has a first edge and a second edge and the second elongate section has a third edge and a fourth edge, the first edge of the first elongate section is mechanically connected to the third edge of the second elongate section.
